(19) United States
(12) Patent Application Publication
(10) Pub. No.: US 2013/0116838 A1
(43) Pub. Date: May 9, 2013

(54) SYSTEM AND DEVICE FOR UTILITY MANAGEMENT

(71) Applicant: Renee Runhua He, Roswell, GA (US)

(72) Inventor: Renee Runhua He, Roswell, GA (US)

(73) Assignee: General Electric Company, Schenectady, NY (US)

(21) Appl. No.: 13/290,906

(22) Filed: Nov. 7, 2011

(51) Int. Cl. G06F 1/26

(52) U.S. Cl. 700/286; 700/295

(57) ABSTRACT

An article of manufacture for an energy system that has one or more tangible, machine-readable media. The machine-readable media have processor-executable instructions encoded thereon. The media includes instructions to receive status data from a network management system. The status data corresponds to a device in the energy system. The media also includes instructions to provide the status data to an asset information system. The media includes instructions to receive asset status data from the asset information system. The media also includes instructions to provide the asset status data to a utility management system.

### BACKGROUND OF THE INVENTION

The subject matter disclosed herein relates to utility systems and, more specifically, to systems and devices for utility management.

A utility system provides power to customers connected to a power grid. Utility management systems, which may be part of a utility operation domain, may include various systems for managing the operation and maintenance of the utility system. For example, utility management systems may include an energy management system (EMS), a distribution management system (DMS), a meter data management system (MDMS), and so forth, for monitoring and/or managing power consumption within the utility system. On the other hand, a network management system (NMS) may be used for managing network elements and devices within the utility system that relate to establishing and maintaining network connectivity. A utility operator may use information from both the network management system and the utility management systems. Unfortunately, the data from the network management system is produced separately from the utility management systems data. Therefore, it may be difficult to establish a relationship between data in the network management system and data in the utility management systems.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, an article of manufacture for an energy system includes one or more tangible, machine-readable media having encoded thereon processor-executable instructions. The media includes instructions to receive device data from a network management system. The device data corresponds to a device added to the energy system. The media also includes instructions to provide the device data to an asset information system. The media includes instructions to receive asset data from the asset information system. The media also includes instructions to provide the asset data to a utility management system.

In a second embodiment, an article of manufacture for an energy system includes one or more tangible, machine-readable media having encoded thereon processor-executable instructions. The media includes instructions to receive status data from a network management system. The status data corresponds to a device in the energy system. The media also includes instructions to provide the status data to an asset information system. The media includes instructions to receive asset status data from the asset information system. The media also includes instructions to provide the asset status data to a utility management system.

In a third embodiment, an energy system includes a device configured to receive utility management system data, to receive asset status data, to correlate the utility management system data with the asset status data, and to provide the correlated data to a graphical user interface.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a block diagram of an embodiment of a utility system including a system correlates data from a network management system with data from a utility management system;

FIG. 2 illustrates a block diagram of an embodiment of the data correlation system of FIG. 1;

FIG. 3 illustrates a flowchart of an embodiment of a method for detecting and publishing data for devices after they are added to the utility system of FIG. 1; and

FIG. 4 illustrates a flowchart of an embodiment of a method for correlating data from the network management system of FIG. 1 with data from the utility management system of FIG. 1.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Further, the term “client” may refer to a computer (e.g., a processor and storage that allows execution and storage of machine-readable instructions to provide the functionality described herein) and/or computer processes running on such computers.

Present embodiments relate to a utility system with a data correlation system for establishing a relationship between data from different data systems of the utility system. Specifically, the data correlation system may receive status data from a network management system (NMS). The status data corresponds to the status of network devices in the utility system (e.g., the status data may indicate whether devices in the network are working properly or are not working properly). The data correlation system may provide the status data to an asset information system (e.g., a database that is updated with network device status data as it is received and correlates the network device status data with utility meters that are affected by the operability of the network devices). The data correlation system may receive asset status data from the asset information system after the status data is correlated with a utility asset (e.g., the data correlation system may receive utility meter data that has been updated based on the status data of network devices that affect the accessibility of the utility meters). The data correlation system may provide the asset status data to a utility management system in a manner that enables the utility management system to use the asset status data within the utility management system (e.g., to show which utility meters have been affected by the status data from the network devices).

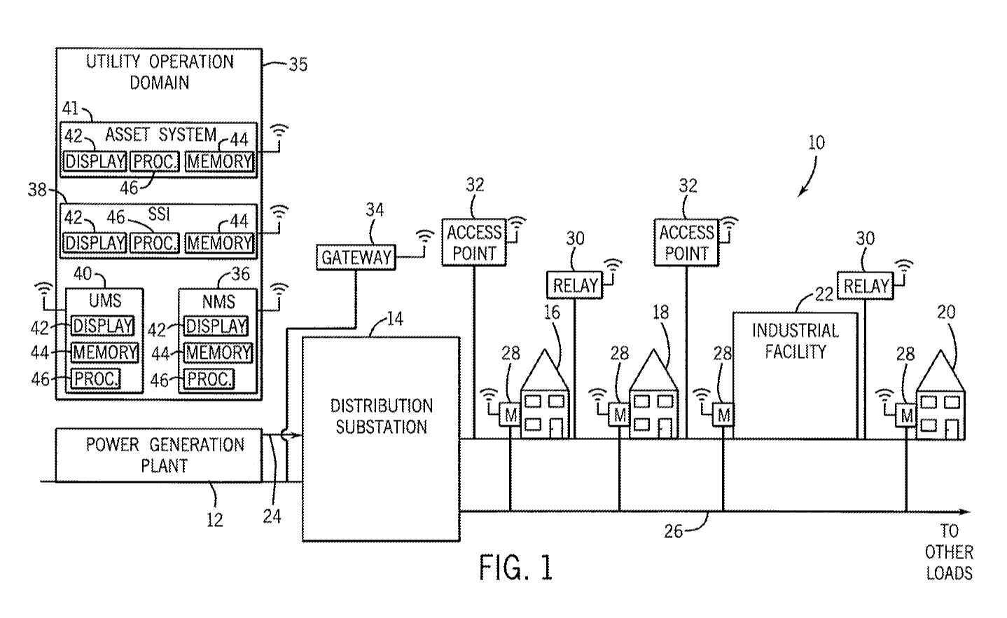

With the foregoing in mind, FIG. 1 illustrates a block diagram of an embodiment of a utility system 10 which may use a system to correlate data from a network management system with data from a utility management system. In the illustrated embodiment, the utility system 10 includes a power generation plant 12 and a distribution substation 14. The power generation plant 12 provides electrical power to loads connected to the utility system 10, such as residences 16, 18, and 20, as well as industrial facility 22. The power generation plant 12 may represent one or more power plants powered by, for example, nuclear fission, burning of fossil fuels (such as coal or natural gas), wind, solar energy, or the like. Electrical power is carried from the power generation plant 12 to the distribution substation 14 using a cable system 24. The distribution substation 14 may include equipment for transforming voltages from high to low with a step-down transformer, or for transforming voltages from low to high with a step-up transformer. Furthermore, the distribution substation 14 may include switches, protection equipment, and control equipment, in addition to one or more transformers, that may be used to distribute electrical power through the utility system 10.

As illustrated, electrical power flows from the distribution substation 14, through a cable system 26 to the residences 16, 18, and 20, and to the industrial facility 22 (e.g., using an underground or overhead cable system 26). Before flowing to the residences 16, 18, and 20, and the industrial facility 22, electrical power flows through utility meters 28. The meters 28 are used to measure the amount of electrical power used by the residences 16, 18, and 20, and the industrial facility 22.

In certain embodiments, the meters 28 may transmit usage, identification, and/or other data to access points 32 using relays 30, while in other embodiments, the meters 28 may transmit data directly to the access points 32. The relays 30 are devices that are used to retransmit data from the meters 28 to the access points 32 when the access points 32 are not within the transmission range of the meters 28. As may be appreciated, the relays 30 may also be used to retransmit data from the access points 32 to the meters 28 (e.g., requests for usage information, software updates, etc.). The access points 32 are devices that are configured to communicate with multiple meters 28 in the utility system 10 (directly or via a relay 30) and provide a communication link between the meters 28 and a wide area network (WAN) of the utility system 10. Using the WAN data may be transmitted from the access points 32, through a gateway 34, and to a utility operation domain 35. The gateway 34 is a device that enables or inhibits communication between the access points 32 and systems of the utility operation domain 35 (e.g., based on the data being communicated).

The utility operation domain 35 may include a network management system (NMS) 36, an enterprise integration system (SSI) 38, a utility management system (UMS) 40, and an asset system 41 (e.g., a grid information system (GIS)). The systems of the utility operation domain 35 communicate together to establish a correlation between data from the NMS 36 with data from the UMS 40. Specifically, the NMS 36 may receive status information relating to the operation of network devices (e.g., meters 28, relays 30, access points 32, gateway 34, etc.) within the utility system 10. As may be appreciated, in certain embodiments, the NMS 36 may communicate directly with the meters 28, the relays 30, and the access points 32 to obtain operational status from these devices (e.g., whether the devices are communicating and functioning properly). It should be noted that the NMS 36 may be used for discovery of network devices, firmware/software updates of network devices, fault detection of network devices, and/or performance monitoring of network devices, for example.

In some embodiments, the NMS 36 may provide data relating to the network devices to the SSI 38. In such embodiments, the NMS 36 may include one or more software modules that enable the NMS 36 to transfer data to/from the SSI 38, to publish data to systems that communicate with the SSI 38 (e.g., make data from the NMS 36 available to other systems), and to subscribe to data from systems that communicate with the SSI 38 (e.g., receive data from other systems). The SSI 38 may make the data from the NMS 36 available to other systems (e.g., publish the data) so that data from the NMS 36 can be correlated with data from other systems. In certain embodiments, the asset system 41 may subscribe to the published NMS 36 data so that the asset system 41 will receive NMS 36 data and be able to correlate the NMS 36 data with asset data in the asset system 41 (e.g., correlate updated status data from network devices with meters 28 that depend on the network devices for communicating meter data).

The asset system 41 may publish the asset data to make it available to systems that communicate with the SSI 38. For example, the UMS 40 may subscribe to the asset data published by the asset system 41. In certain embodiments, the UMS 40 may receive information from the meters 28 through the network components in order to track the usage and other energy parameters provided by the meters 28. The UMS 40 may also receive asset data and display information showing a relationship between the asset data and the UMS 40 data (e.g., show a visual indication when communication with a meter 28 is not possible due to an inoperable network device). Thus, using the SSI 38, data may be shared between systems so that a correlation between the NMS 36 data and the UMS 40 data can be made. It should be noted that the UMS 40 may also include one or more software modules that enable the UMS 40 to transfer data to/from the SSI 38 (e.g., to publish data to systems that communicate with the SSI 38, and to subscribe to data from systems that communicate with the SSI 38).

As illustrated, the meters 28, the relays 30, the access points 32, the gateway 34, the NMS 36, the SSI 38, the UMS 40, and the asset system 41 may all communicate together using wireless communications. Further, as may be appreciated, the meters 28, the relays 30, the access points 32, the gateway 34, the NMS 36, the SSI 38, the UMS 40, and the asset system 41 may also communicate with wired communication, or some combination of wireless and wired communication.

In the present embodiment, the NMS 36, the SSI 38, the UMS 40, and the asset system 41 each include a display 42, memory and/or storage 44, and a processor 46. Each of these devices (e.g., the display 42, memory and/or storage 44, and the processor 46) may include hardware elements (including circuitry), software elements (including computer code stored on a computer-readable medium) or a combination of both hardware and software elements. Further, the display 42 may be any type of display for showing information, such as a correlation between network management system data and energy management system data. The processor 46 and/or other data processing circuitry may be operably coupled with the memory and/or the nonvolatile storage 44 to execute instructions. Such programs or instructions executed by the processor 46 may be stored in any suitable article of manufacture that includes one or more tangible, computer-readable media at least collectively storing the instructions or routines, such as the memory and/or the nonvolatile storage 44.

The memory and/or the nonvolatile storage 44 may include any suitable articles of manufacture for storing data and executable instructions, such as random-access memory, read-only memory, rewritable flash memory, hard drives, and optical discs. It should be noted that the illustrated systems (e.g., the NMS 36, the SSI 38, the UMS 40, and the asset system 41) are merely one example of a particular implementation of such systems and are intended to illustrate the types of components that may be present in the systems. It should also be noted that the processor 46 and/or other data processing circuitry may be generally referred to herein as “data processing circuitry.” This data processing circuitry may be embodied wholly or in part as software, firmware, hardware, or any combination thereof.

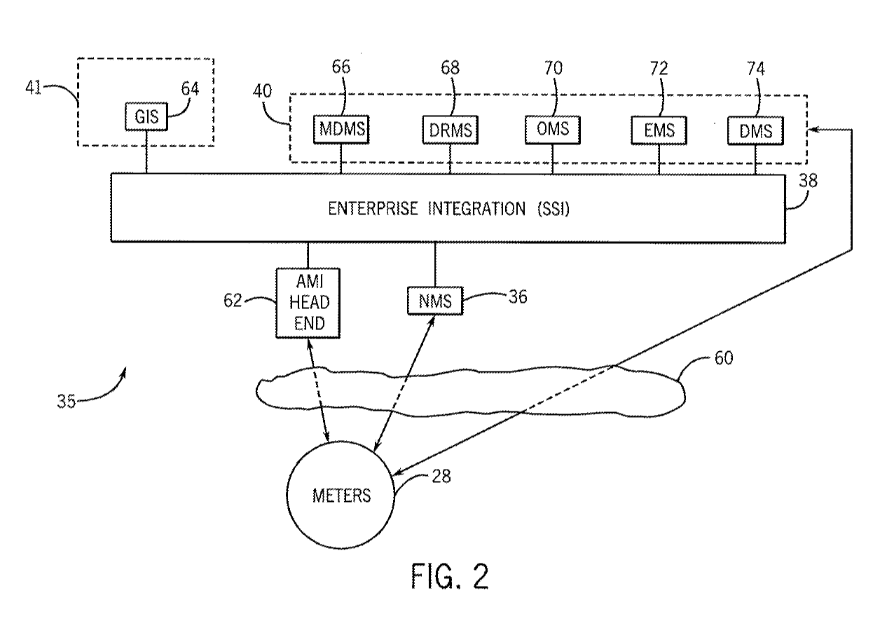

FIG. 2 illustrates a block diagram of the utility operation domain 35 that includes systems used to correlate data from the NMS 36 with data from the UMS 40. For the NMS 36 to receive data relating to the health of the meters 28, the meters 28 communicate with the NMS 36 through a network 60. The network 60 may include the network devices illustrated in FIG. 1 (e.g., relays 30, access points 32, the gateway 34) or any other suitable network devices that allow the NMS 36 to communicate with the meters 28. Further, each of the network devices (e.g., relays 30, access points 32, the gateway 34) provide data relating to their health to the NMS 36. The NMS 36 uses this collective data to manage the network devices and to determine which network devices need to be repaired. In certain embodiments, the NMS 36 may provide data relating to the health of the network devices to the SSI 38.

As illustrated, the SSI 38 may also receive information about the meters 28 via an advanced metering infrastructure (AMI) head end 62. The AMI head end 62 may be provided by the meters 28 manufacturers to allow direct communication with the meters 28. Turning to the UMS 40, the UMS 40 receives data (e.g., data relating to energy usage) from the meters 28 via the network 60. Further, the UMS 40 may send data to the meters 28 using the network 60 (e.g., power off event, power on event, pinging, polling, etc.). Therefore, the UMS 40 is dependant on the proper operation of the network 60 for sending data to and receiving data from the meters 28. As such, if network devices are not functioning properly, the UMS 40 may not be able to communicate with the meters 28 to obtain data and the UMS 40 may not know that a network device is not functioning properly (e.g., the NMS 36 does not communicate problems with the network devices directly to the UMS 40). Thus, the systems of the utility operation domain 35 may be used to identify a relationship between the NMS 36 data and the UMS 40 data so that operators using the UMS 40 may be notified when communication with the meters 28 are unavailable due to the health of a network device.

To assist in data correlation, the utility operation domain 35 includes the asset system 41. In the present embodiment, the asset system 41 includes a grid information system (GIS) 64 that is used to store data related to assets that are part of the utility system 10 and to establish a relationship between asset data of related assets. For example, if a network device is not operational, there may be a number of meters 28 that cannot be communicated with over the network. Therefore, the GIS 64 includes information to determine which meters 28 are affected by an inoperable network device and to update the database record of the inaccessible meters 28 to show that the meters 28 are inaccessible due to the inoperable network device. To accomplish this, the GIS 64 may assign a unique identifier to each utility and/or network device installed in the utility system 10. Further, the GIS 64 may store status information that relates to each utility and/or network device that is installed in the utility system 10. As such, device information and device status information may be stored in a single database record for each utility and/or network device. In addition, the database records of related devices are linked together so that if a network device is inoperable, the GIS 64 includes a link showing which meters 28 are affected by the inoperable network device, for example. Therefore, when the UMS 40 obtains device information from the GIS 64, the UMS 40 may also obtain device status information.

As illustrated, the UMS 40 may include multiple different management subsystems for managing the utility system 10. Specifically, the UMS 40 may include a meter data management system (MDMS) 66 (e.g., for managing meter data), a demand response management system (DRMS) 68 (e.g., for managing electrical power demand), an outage management system (OMS) 70 (e.g., for managing utility system 10 outages), an energy management system (EMS) 72 (e.g., for general energy management), and a distribution management system (DMS) 74 (e.g., for managing electrical power distribution). As may be appreciated, each of the subsystems of the UMS 40 may communicate with the SSI 38. Further, each of the subsystems of the UMS 40 may include one or more software modules that enable the subsystems to transfer data to/from the SSI 38, to publish data to systems that communicate with the SSI 38, and to subscribe to data from systems that communicate with the SSI 38.

In certain embodiments, the SSI 38 may provide a communication link between the various systems that are integrated with the SSI 38. The communication link may operate using one of many protocols, including, dynamic host configuration protocol (DHCP), domain name system (DNS), network time protocol (NTP), lightweight directory access protocol (LDAP), and/or authentication, authorization, and accounting protocol (AAA). Further, the systems that connect to the SSI 38 may publish data and/or subscribe to published data. For example, the NMS 36 may publish its data and the GIS 64 may subscribe to data published by the NMS 36. Further, the GIS 64 may publish its data, and the UMS 40 systems may subscribe to the GIS 64 data. Thus, data from the NMS 36 may be shared with the UMS 40 systems using the SSI 38. In certain embodiments, the SSI 38 may inform subscribers when updated data (e.g., new, changed, deleted, etc.) is published and inform the subscribers concerning what data has been updated so that the subscriber can efficiently retrieve the updated data. It should be noted that the UMS 40 and the NMS 36 may in certain embodiments be integrated into a single system. However, such a system may not operate efficiently and/or may be more expensive to produce and operate than a modular system. Further, in some embodiments, the UMS 40 may communicate directly with the NMS 36 without using the SSI 38 to handle communication between the systems. In such an embodiment, the UMS 40 may include information (e.g., in a database) that can be used to link network device status data from the NMS 36 with associated meters 28.

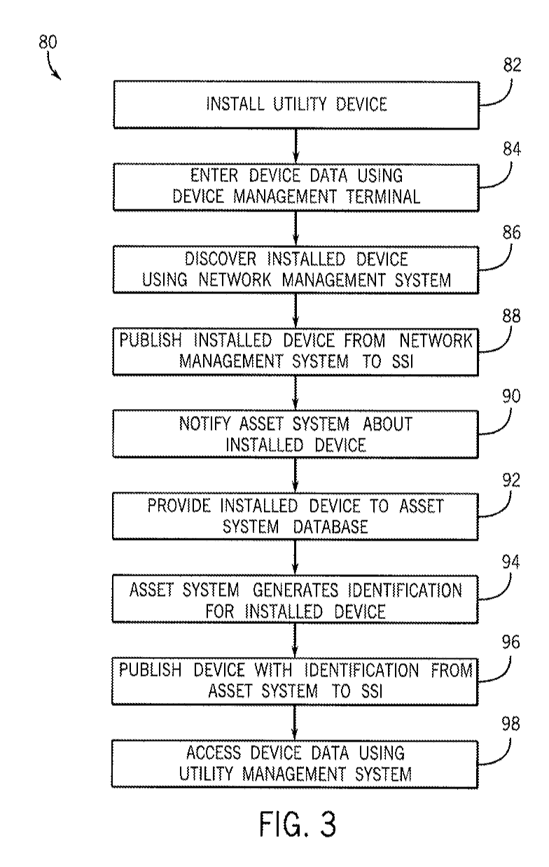

As previously discussed, the NMS 36 may be used to discover utility devices that are added to the utility system 10 and may use systems of the utility operation domain 35 to update subscribing systems with information about the utility devices. Specifically, FIG. 3 illustrates a flowchart of a method 80 for detecting and publishing data from utility devices when they are installed into the utility system 10. As may be appreciated, the items performed by this method 80 may save the utility system 10 time and money by eliminating the need to manually input information about the utility devices into the utility management systems. Further, some or all of the method 80 may be performed using an article of manufacture having one or more tangible, machine-readable media (e.g., memory and/or storage 44) with processor-executable instructions encoded thereon.

At block 82, a utility device is installed into the utility system 10 (e.g., meter 28, relay 30, access point 32, recloser, cap banker, switch, etc.). Next, at block 84, device data for the utility device is entered by an operator using a device management terminal (e.g., a computer connected to the utility device). For example, the operator may enter the device serial number, model number, model type, longitude and/or latitude of the device location (or another location identifier), etc. As may be appreciated, in certain embodiments, the operator may not need to enter any data into the device management terminal (e.g., data may be detected from the utility device when it is connected to the system 10).

Then, at block 86, the NMS 36 discovers that the utility device has been installed into the utility system 10. In particular, the NMS 36 may discover the utility device using any suitable method (e.g., by scanning for devices, device bootstrapping, etc.). After the NMS 36 discovers the utility device, at block 88, the NMS 36 publishes information about the installed device to the SSI 38. If the GIS 64 is configured to subscribe to NMS 36, at block 90, the GIS 64 (i.e., asset system) is notified by the SSI 38 that the NMS 36 has published new data. Next, at block 92, the SSI 38 provides data about the installed utility device to the GIS 64. Then, at block 94, the GIS 64 processes the information about the installed utility device and generates a unique identification (e.g., device identifier) for the utility device. The GIS 64 also populates a database record for the utility device and populates the database record with available information.

At block 96, the GIS 64 publishes information about the utility device, including the unique identification, to be available for any subscribing systems. Then, at block 98, if the UMS 40, or one of the subsystems of the UMS 40, subscribes to the GIS 64, the subscribing system will be notified about the information for the new utility device and the subscribing system will be able to access the data for the new utility device. In certain embodiments, when subscribing to the GIS 64, the UMS 40 may make a request to the SSI 38 to be a subscriber to the GIS 64 data. Using the method 80 to automatically detect new utility devices added to the utility system 10 simplifies the process for adding new utility devices. Further, time is saved and resources are conserved because the various systems (e.g., GIS 64 and UMS 40) are updated quickly and accurately. It should be noted that although the NMS 36 was used in the method 80 to discover installed utility devices, in other embodiments, another management system of the utility system 10 may be used to discover installed utility devices.

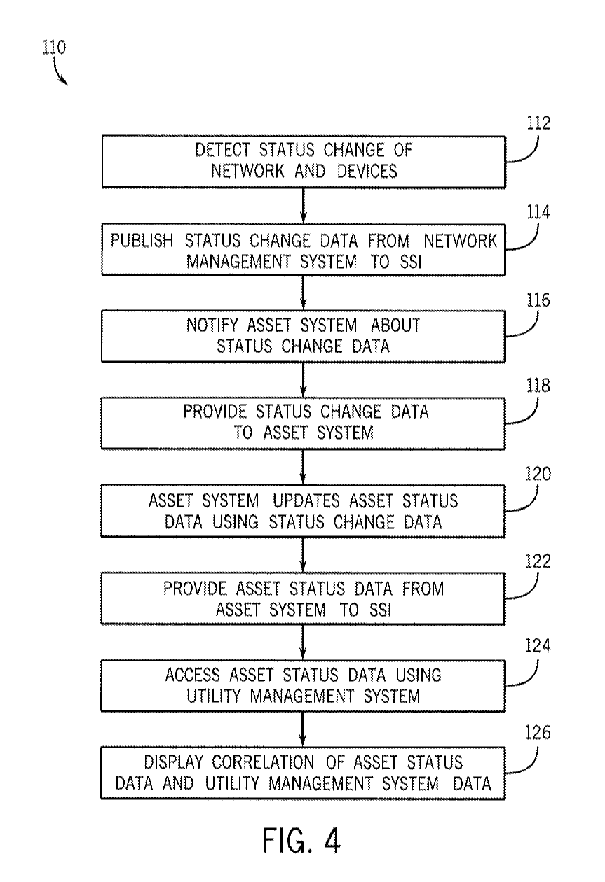

The systems of the utility operation domain 35 may also be used to identify a relationship between data from the NMS 36 with data from the UMS 40, as previously described. Specifically, FIG. 4 illustrates a flowchart of a method 110 for correlating data from the NMS 36 with data from the UMS 40. Some or all of the method 110 may be performed using an article of manufacture having one or more tangible, machine-readable media (e.g., memory and/or storage 44) with processor-executable instructions encoded thereon. At block 112, the NMS 36 detects a status change of the network or a device in the network (e.g., when a device changes from a normal operation status to a fault status or a device changes from a fault status to a normal operation status). Next, at block 114, the NMS 36 publishes the status change data to the SSI 38 to make the status change data available to any subscribers. Then, at block 116, the SSI 38 notifies subscribers about the status change data. For example, the SSI 38 may notify the GIS 64 about the status change if the GIS 64 subscribes to updates from the NMS 36.

After being notified about the data, at block 118, the SSI 38 provides the status change data to the GIS 64 (e.g., or another asset system). Next, at block 120, the GIS 64 updates the database record for the asset to show the updated asset status (e.g., either normal operation status or fault status). Further, the GIS 64 updates any related assets that depend on the updated asset. For example, one or more meters 28 may depend on the operability of an access point 32 for accessing the meters 28. Therefore, if the access point 32 is inoperable, the GIS 64 may update the database records for the meters 28 that depend on the operability of the access point 32 to show that communication with the meters 28 is currently unavailable due to the inoperable access point 32.

Then, at block 122, the GIS 64 publishes the asset status data of all assets that have been updated to the SSI 38. Therefore, any subscribers to the GIS 64 will be notified and have access to the updated asset status data. In certain embodiments, the updated asset status data includes a device identifier for each device that has an updated status. At block 124, the UMS 40, or a subsystem of the UMS 40 receives subscribed data from the GIS 64. The updated asset status data from the GIS 64 allows the UMS 40 to provide additional details for use with energy management system data (e.g., energy management system data may include meter data, outage data, distribution data, demand data, energy data, etc.).

Then, at block 126, the correlation of the asset status data and the energy management system data may be displayed (e.g., using a graphical user interface) to provide an operator with a visual indication of the data correlation. For example, the display 42 of the UMS 40 may show unreachable meters 28 (e.g., due to a network disturbance) with a visual indication (e.g., in a red color, crossed out, displayed on a list of unreachable meters 28, etc.). Further, the UMS 40 may disable features that relate to unreachable meters 28 (e.g., disable pinging and/or polling of meter data for devices that are currently inaccessible) and display the disabled features using a graphical user interface. Conversely, if a meter 28 switches from being unreachable to being reachable, the UMS 40 may remove visual indications showing that meters 28 are unreachable and may restore disabled features. As may be appreciated, if the UMS 40 uses energy consumption data for reporting or data analysis, using the data indicating unreachable meters 28 the UMS 40 may eliminate unreachable meters 28 from the reports or data analysis.

Technical effects of the invention include the ability to add devices to a utility system 10 dynamically. As such, the utility system 10 may save time and money by eliminating the need to manually input information about the utility devices into the utility management systems. Further, data from the NMS 36 may be correlated to data in the UMS 40 to identify utility devices that are inaccessible due to network outages. Thus, resources are conserved by having the correlated data available to be presented to an operator.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An article of manufacture for an energy system comprising:
one or more tangible, machine-readable media having encoded thereon processor-executable instructions comprising:
instructions to receive device data from a network management system, the device data corresponding to a device added to the energy system;
instructions to provide the device data to an asset information system;
instructions to receive asset data from the asset information system; and
instructions to provide the asset data to a utility management system.

2. The article of manufacture of claim 1, wherein the device data comprises a serial number of the device.

3. The article of manufacture of claim 1, wherein the device data comprises a model number of the device.

4. The article of manufacture of claim 1, wherein the device data comprises a location identifier of the device.

5. The article of manufacture of claim 1, wherein the asset data comprises a device identifier that corresponds to the device data from the device added to the energy system.

6. The article of manufacture of claim 1, wherein the instructions to provide the asset data to a utility management system comprise instructions to provide the asset data to the utility management system after a request from the utility management system is received.

7. The article of manufacture of claim 1, wherein the instructions to provide the asset data to a utility management system comprise instructions to provide the asset data to the utility management system after the device is added to the energy system.

8. The article of manufacture of claim 1, wherein the processor-executable instructions comprise instructions to receive a notification from the network management system when the device is added to the energy system.

9. An article of manufacture for an energy system comprising:
one or more tangible, machine-readable media having encoded thereon processor-executable instructions comprising:
instructions to receive status data from a network management system, the status data corresponding to a device in the energy system;
instructions to provide the status data to an asset information system;
instructions to receive asset status data from the asset information system; and
instructions to provide the asset status data to a utility management system.

10. The article of manufacture of claim 9, wherein the device comprises at least one of a relay, a gateway, or an access point.

11. The article of manufacture of claim 9, wherein the status data comprises an indication of whether the device is operating properly.

12. The article of manufacture of claim 9, wherein the asset status data comprises an indication of inoperable devices.

13. The article of manufacture of claim 9, wherein the asset status data comprises a device identifier that corresponds to the status data from the device in the energy system.

14. The article of manufacture of claim 9, wherein the asset information system is configured to determine whether an asset is accessible based at least partly on the status data.

15. An energy system comprising:
a device configured to receive utility management system data, to receive asset status data, to correlate the utility management system data with the asset status data, and to provide the correlated data to a graphical user interface.

16. The system of claim 15, wherein the utility management system data comprises at least one of meter data, outage data, distribution data, demand data, or energy data.

17. The system of claim 15, wherein the asset status data comprises a status of network devices in a network management system.

18. The system of claim 15, wherein correlating the utility management system data with the asset status data comprises determining which devices in the utility management system are affected by network devices in the network management system that are not functioning properly.

19. The system of claim 15, wherein the graphical user interface is configured to present utility management system devices and to present an indication relating to devices that are not accessible due to a network disturbance.

20. The system of claim 15, wherein the graphical user interface is configured to present utility management system devices and to deactivate features relating to the devices that are currently inaccessible.
